(19) United States
(12) Patent Application Publication
(10) Pub. No.: US 2003/0101233 A1
(43) Pub. Date: May 29, 2003

(54) Browser with barcode input

(76) Inventors: Kenneth Liou, Taipei Hsien (TW); Kuo-Nien Liu, Taipei Hsinen (TW)

Correspondence Address: RABIN & BERDO, P.C., 1101 14th Street, N.W., Suite 500, Washington, DC, 20005, US

(21) Appl. No.: 09/994,802

(22) Filed: Nov. 28, 2001

(51) Int. Cl. G06F 15/16

(52) U.S. Cl. 709/218

(57) ABSTRACT

A browser with barcode input comprising a barcode scan input device, a scan switch, an indication LED, a mobile phone output interface, an USB output interface, a LCD display, a keypad and a switch, all the devices are connected to a built-in microprocessor. The barcode scan input device scans the barcode format web site addresses and converts the data into digital signals; the digital signals are processed by a microprocessor and stored into memory. Several hotkeys can be pre-defined for the corresponding web site addresses. When a computer or a mobile phone is connected to the present invention, users can press the hotkey to activate the Browser for the desired web site address or run Outlook for E-mail contents.

### BACKGROUND OF THE INVENTION

I. Field of the Invention

This invention relates generally to a browser with barcode input and, more specifically, to a browser with barcode input that scans in the barcode format web site addresses and converts the data into digital signals for being stored into the memory. Several hotkeys can be pre-defined for the corresponding web site addresses. When a computer or a mobile phone is connected to the present invention, users can press the hotkey to activate the Browser for the desired web site address or run Outlook for the E-mail contents. When the USB output interface is connected to a computer, the present invention can downloads the edited web site addresses from the computer into the memory of the present invention; or transmit the web site addresses in the memory to the computer for edition or store.

II. Description of the Prior Art

Heretofore, it is known that the applications of Internet shorten the distance among people, broaden people's vision, and increase mutual understanding between countries, a great achievement of human civilization. Currently, people are using personal computer, notebook computer or personal data assistant (PDA) to access Internet; they all need keyboard or keypad as input device to key in web site address, in additional to web site address, other procedures might also need for keyboard as input, all the access processes are very inconvenient for those who are not familiar with computer.

Moreover, mobile phones are also very popular thus people can use mobile phones to conveniently access Internet for more availability. However, the difficulty to input keys makes mobile phone Internet applications a bottleneck, therefore mobile phone Internet access is not so effectively.

### SUMMARY OF THE INVENTION

It is therefore a primary object of the invention to provide a browser with barcode input that scans and memorizes the barcode format web site addresses, and links to a computer or a mobile phone to activate Browser directly for desired web site or activate Outlook for the contents of E-mail faster without keystrokes.

It is an objective of this invention to provide a browser with barcode input in which contains a USB output interface that links to a personal computer, the USB output interface can transmit the web addresses to PC for editing or store and transmit the edited addresses back to the memory of the present invention.

It is still an objective of this invention to provide a browser with barcode input that can print the web addresses from a printer in barcode format and have information of the web addresses attached below for further identification.

In order to achieve the objective set forth, a browser with barcode input in accordance with the present invention comprises a barcode scan input device, a scan switch, an indication LED, a mobile phone output interface, an USB output interface, a LCD display, a keypad and a switch, all the devices are connected to a built-in microprocessor. The barcode scan input device scans in the barcode format web site addresses and converts the data into digital signals; the digital signals are processed by a microprocessor and stored into memory. Several hotkeys can be pre-defined for the corresponding web site addresses. When a computer or a mobile phone is connected to the present invention, users can press the hotkey to activate the Browser for the desired web site address or run Outlook for E-mail contents. When the USB output interface is connected to a computer, the present invention can downloads the edited web site addresses from the computer into the memory of the present invention, or transmit the web site addresses in the memory to the computer for edition or store.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a block diagram of the present invention;

FIG. 3 is a flowchart for program setting in accordance with the present invention.

### DESCRIPTION OF THE PREFERRED EMBODIMENT

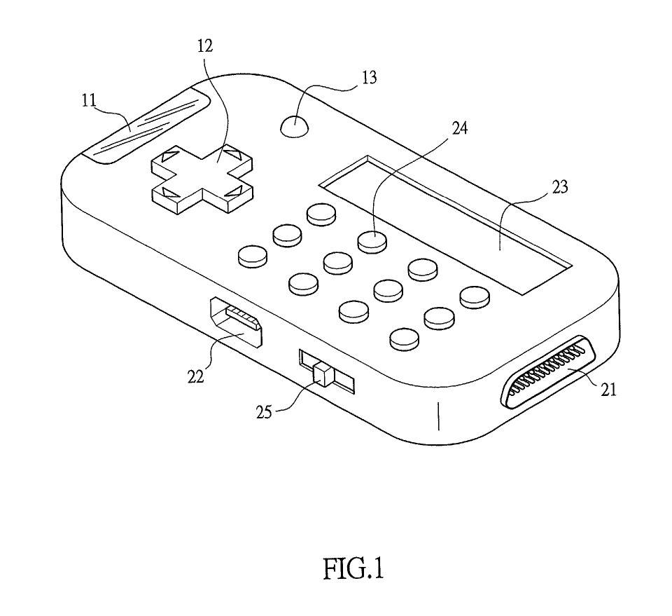

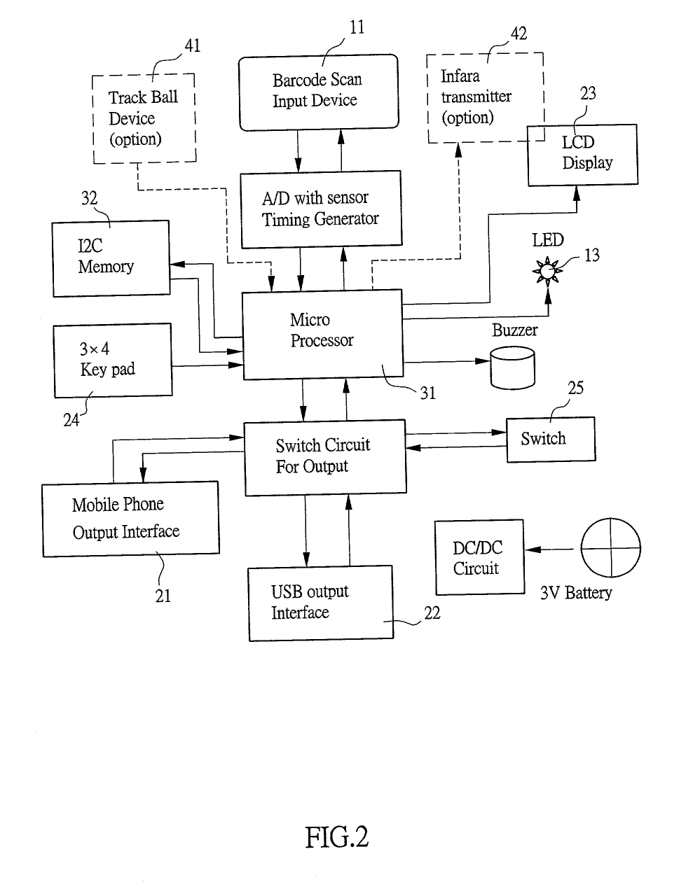

Referring to FIG. 1 and FIG. 2, the present invention is composed of a barcode scan input device 11, a scan switch 12, an indication LED 13, a mobile phone output interface 21, an USB output interface 22, a LCD display 23, a keypad 24 and a switch 25. The functions of each component are described below:

The barcode scan input device 11 can be a CMOS sensor, a CCD camera, a CIS sensor or a pen barcode reader. The scan switch 12 activates the barcode reading operation and converts the data into digital signals; the digital signals are processed by a microprocessor 31 and stored into memory 32 or transmitted out to other devices; the indication LED 13 flashes to indicate the barcode reading operation is going and stop flashing when it finish reading.

The mobile phone output interface 21 is connected to a mobile phone.

The USB output interface 22 is connected to computers and other peripheral devices.

The keypad 24 is to preset and edit the web site addresses to be stored, also used to preset hot keys for faster web site addresses to go to Internet.

The LCD display 23 displays the data read from the barcode scan input device 11 and the codes input by the keypad 24 for operations.

The switch 25 controls the input/output between the barcode scan input device 11 and the USB output interface 22.

Based on above description, users can press a hotkey defined earlier to activate the microprocessor 31 fetches the preset data or web site address from the memory 32 and activate web Browser, then go to Internet through a PC, a notebook computer, a PDA or a mobile phone, or activate Outlook for E-mails contents.

Users can also change the switch 25 to have the USB output interface 22 as data I/O device; the data in the memory 32 can be transmitted through the USB output interface 22 to the computer that links to Internet or to a printer, the data compiled by the computer can be transmitted back to the memory 32.

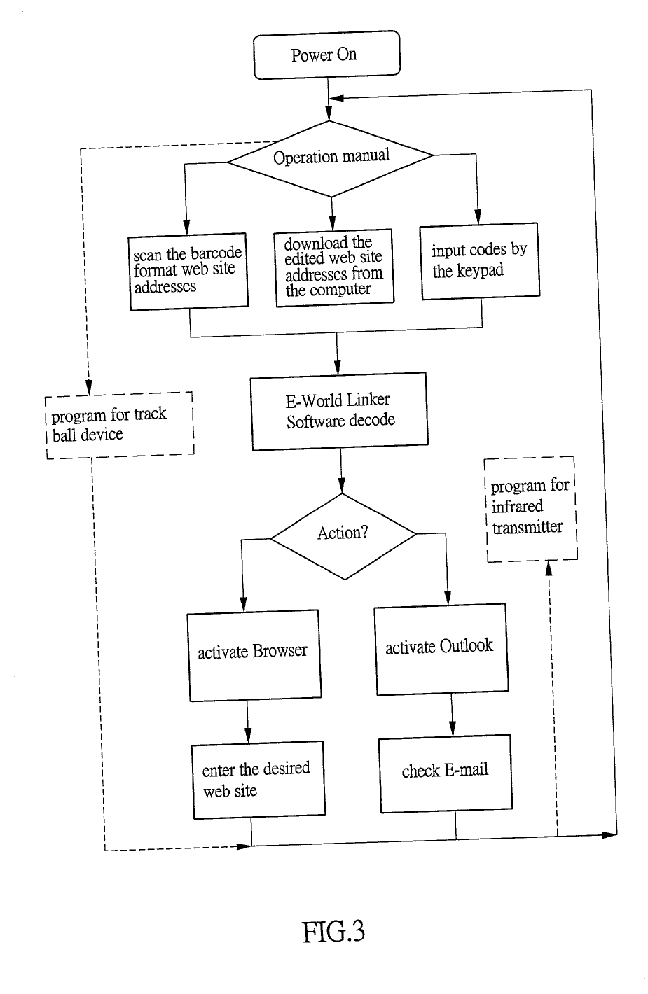

Refer to FIG. 3, the present invention needs an E-World Linker application software as the Windows driver; when this driver is installed into the microprocessor 31, the driver stays permanently and runs as desired.

E-World Linker application software includes following functions:

Web site address decoder: it reads and decodes the data from the barcode reader and translates the data into real IP (Internet Protocol), activates Browser and enter the desired web site, or activates Outlook to see the contents of E-mails.

Web site address editor: it can call other character editors, such as Notepad of Windows, users can edit the web site addresses and store those into the memory of the computer linked to Internet, or print those out in barcode format.

Print: it can print the web addresses from a printer in barcode format and have information of the web addresses attached below for reference.

Down-load/up-load web address: it can down-load the edited web address to the present invention or up-load the web address to computer, the indicator LED flashes when it down-loading or up-loading and stop flashing when the task is done.

Users can apply the keypad 24 to set functions: press from 00 to 99 from one out of 100 combinations (01 for example) then press Set key, the indication LED 13 starts flashing, when barcode scan input device 11 finish scanning, the indication LED 13 stops flashing, the web site address is now stored into the memory 32. When the mobile phone output interface 21 or the USB output interface 22 is connected to a mobile phone or a computer, users can press 0 and 1 key to activate the microprocessor 31 to fetch the corresponding web site address in the memory 32 and run the Browser for the desire web site. When this web address is to be deleted, users can press Clear key first then 0 and 1 key and press Clear key one more time, the defined data is removed.

Based on above description, the present invention applies two digits as Hotkey combinations; such implementation allows computer iliteratures can visit Internet easily. The E-commerce Internet shopping can prevail faster.

By the same method, the present invention can preset the names and addresses for E-mail contents. The present invention can be applied as business card book, when all the data and ID's are scanned and stored into memory, users can just input hotkeys or scan the barcode of the business card and enter the Internet for desired information, users do not need to organize business cards or carry those cards around.

When the USB output interface 22 is connected to a computer, the data can be downloaded to the memory 32 of the present invention, the web site addresses in the memory 32 can also be transmitted to the computer to edit or store.

The dash-line block as shown in FIG. 2 and FIG. 3, a track ball device 41 or an infrared transmitter 42 can be connected to the microprocessor 31 as other input devices. The infrared transmitter 42 can work with a web TV and remotely control it; such implementation is very user-friendly.

While a preferred embodiment of the invention has been shown and described in detail, it will be readily understood and appreciated that numerous omissions, changes and additions may be made without departing from the spirit and scope of the invention.

What is claimed is:

1. A browser with barcode input comprising:
a barcode scan input device reading the barcode and converting the data into digital signals that is processed by a microprocessor and stored into memory or transmitted out to other devices;
an indication LED flashing to indicate the barcode reading operation is going and stop flashing when the reading is done;
a mobile phone output interface for connecting to a mobile phone;
an USB output interface connected to computers or peripheral devices;
a keypad to preset and edit the web site addresses to be stored, said keypad also used to preset hot keys for faster web site addresses to access Internet;
a LCD display displaying the data read from said barcode scan input device and the codes input by said keypad for operations;
a switch controlling the input/output between said barcode scan input device and said USB output interface.

2. The browser with barcode input recited in claim 1, wherein said USB output interface can transmit the preset data to a computer or a printer, and download the edited web site addresses from a computer.

3. The browser with barcode input recited in claim 1, wherein said microprocessor has an E-World Linker application software as the Windows driver with following functions:
Web site address decoder: it reads and decodes the data from barcode reader and translates the data into real IP (Internet Protocol), activates Browser and enter the desired web site, or activates Outlook to see the contents of E-mail;
Web site address editor: it can call other character editors, such as Notepad of Windows, users can edit the web site addresses and store those into the memory of the computer linked to Internet, or print those out in barcode format;
Print: it can print the web addresses from a printer, or in barcode format and have information of the web addresses attached below;
Down-load/up-load web address: it can down-load the edited web address to the present invention or up-load the web address to computer.
